(19) United States
(12) Patent Application Publication
(10) Pub. No.: US 2007/0173077 A1
(43) Pub. Date: Jul. 26, 2007

(54) UNIVERSAL SERIAL BUS (USB) NETWORK ADAPTER CONNECTABLE TO EXTERNAL ANTENNA

(75) Inventor: Jui-Ming Wang, Yongkang City (TW)

Correspondence Address: KAMRATH & ASSOCIATES P.A., 4825 OLSON MEMORIAL HIGHWAY, SUITE 245, GOLDEN VALLEY, MN, 55422, US

(73) Assignee: HWA YAO TECHNOLOGIES CO., LTD., Yongkang City (TW)

(21) Appl. No.: 11/307,115

(22) Filed: Jan. 24, 2006

(51) Int. Cl. H01R 39/00

(52) U.S. Cl. 439/1

(57) ABSTRACT

The present invention relates to a USB network adapter, especially relates to a USB network adapter comprising a wireless network interface card contained in upper and lower shells and having a coaxial connector extending from a signal receiver of a wireless network interface card. The upper and lower shells having a half circular opening at one end, a half hexagonal flange located adjacent the half circular opening and a seat having a half circular recess for firmly holding the coaxial connector therebetween. Whereby, the coaxial connector is connectable a coaxial connector 7 extending from an antenna to enhance the quality of the wireless communications.

### BACKGROUND OF THE INVENTION

1. Field of Invention

The present invention relates to Universal Serial Bus (USB) network adapters and more particularly to an external USB network adapter connectable to various types of antennas.

2. Related Art

Wireless network is advantageous over wired local area network (LAN). For example, no wire installations are required (i.e., cost reduction). Also, a great number of end users are able to have access to a wireless network at the same time. In contrast, only a limited number of end users are allowed to have access to a wired network at the same time because only a limited number of ports are available by a device connected to the wired network. Also, use is not hindered by space limitation (i.e., easy use). It is anticipated that wired network will be replaced by wireless network in a near future.

For keeping pace with the trend, a variety of wireless USB network cards or adapters for laptop computers are developed by manufacturers of the art and are commercially available. Thus, a user may operate a laptop computer connected to an external wireless USB network card device to connect to the Internet. The wireless USB network card device has a size substantially the same as a flash disk. Hence, it is portable. That is why wireless USB network card devices are gradually gaining popularity among people.

However, the conventional wireless USB network card devices are suffered relatively weak in power due to no wired connection. Also, its signal receiving capability is poor. It is typical that a user operating a laptop computer connected to an external wireless USB network card device may have difficulties of connecting to the Internet if the user is located in a geographically obstructed area. A user may install an antenna in a laptop computer for overcoming the drawback. However, electromagnetic (EM) radiated by the antenna is also strong. This is not good to health. Thus, a need for improvement exists.

### SUMMARY OF THE INVENTION

It is therefore an object of the present invention to provide a USB network adapter comprising a wireless network interface card contained in upper and lower shells and having a USB connector for connecting to a computer through a USB port; further comprising a coaxial connector extending from a signal receiver of the wireless network interface card and connectable to a coaxial connector of an antenna. Each of the upper and lower shells having a half circular opening at one end, a half hexagonal flange located adjacent the half circular opening and a seat having a half circular recess for firmly holding the coaxial connector therebetween.

The above and other objects, features and advantages of the present invention will become apparent from the following detailed description taken with the accompanying drawings.

### BRIEF DESCRIPTION OF THE DRAWINGS

FIG. 1 is an exploded perspective view of a preferred embodiment of a USB network adapter according to the invention;

FIG. 2 is a perspective view of the assembled USB network adapter in FIG. 1; and

FIG. 3 is an environmental view of the USB network adapter being adapter to interconnect a laptop computer and an external antenna.

### DETAILED DESCRIPTION OF THE INVENTION

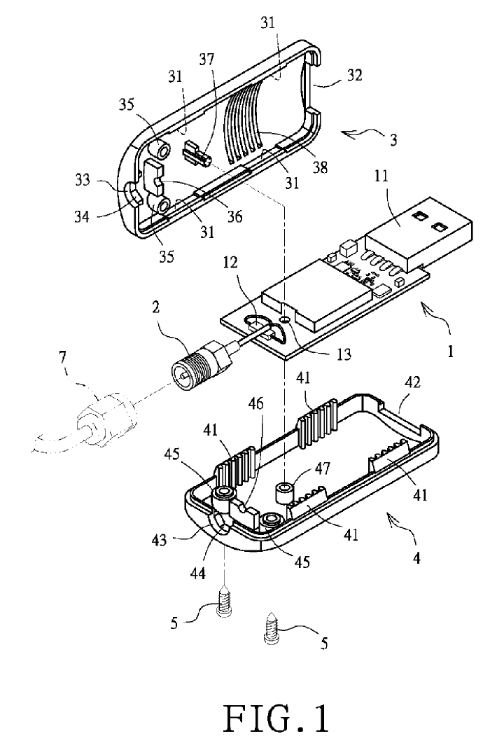

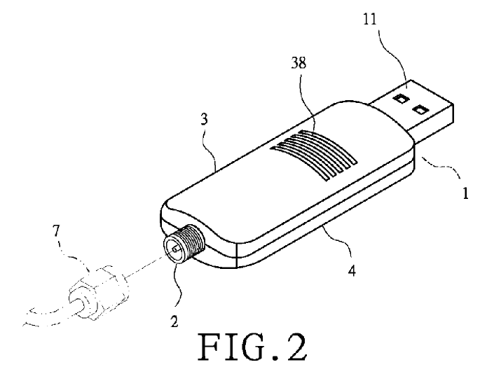

Referring to FIGS. 1 and 2, a USB network adapter in accordance with a preferred embodiment of the invention is shown. The USB network adapter comprises a wireless network interface card 1, a coaxial connector 2, an upper shell 3 and a lower shell 4.

The network interface card 1 includes a USB connector 11 at one end, a through hole 13, a signal receiver 12 at the opposite end, and a coaxial connector 2 extending from the signal receiver 12.

The upper shell 3 includes a plurality of grooves 31 at both sides, a rectangular opening 32 at one end corresponding to the USB connector 11, a half circular opening 33 at the other end corresponding to the coaxial connector 2, a half hexagonal flange 34 located adjacent the half circular opening 33, two side holed cylinders 35 proximate the flange 34, a seat 36 having a half circular recess disposed between the holed cylinders 35, an intermediate peg 37 positioning related to the hole 13, and a plurality of grilles 38 for releasing heat generated from inside of the USB network adapter during operation.

The lower shell 4 includes a plurality of projections 41 at both sides, a rectangular opening 42 at one end corresponding to the USB connector 11, a half circular opening 43 at the other end corresponding to the coaxial connector 2, a half hexagonal flange 44 located adjacent the half circular opening 43, two side holed cylinders 45 proximate one end, a seat 46 having a half circular recess disposed between the holed cylinders 45, and an intermediate holed cylinder 47.

In assembly, the wireless network interface card 1 with the coaxial connector 2 is set on the lower shell 4 with the coaxial connector 2 rested on both the half circular opening 43 and the half hexagonal flange 44, and the parallelepiped USB connector 11 rested on the rectangular opening 42. The upper shell 3 is then covered on the assembled lower shell 4 with the peg 37 being inserted through the through hole 1 3 into the holed cylinder 47. The respective projection 41 is inserted into the respective groove 31. The seats 36 and 46 are attached together with a conductor interconnecting the signal receiver 12 and the coaxial connector 2 anchored therebetween, and the half hexagonal flange 34 is attached to the half hexagonal flange 44 to form a hexagonal flange on an outer surface of the coaxial connector 2. The holed cylinders 35 are aligned with the holed cylinders 45, and the rectangular opening 32 are aligned with the rectangular opening 42 for the USB connector 11 anchored therebetween. Finally, screws 5 are screwed into the holed cylinders 45 and the holed cylinders 35 for fastening the wireless network interface card 1, the lower shell 4, and the upper shell 3 together.

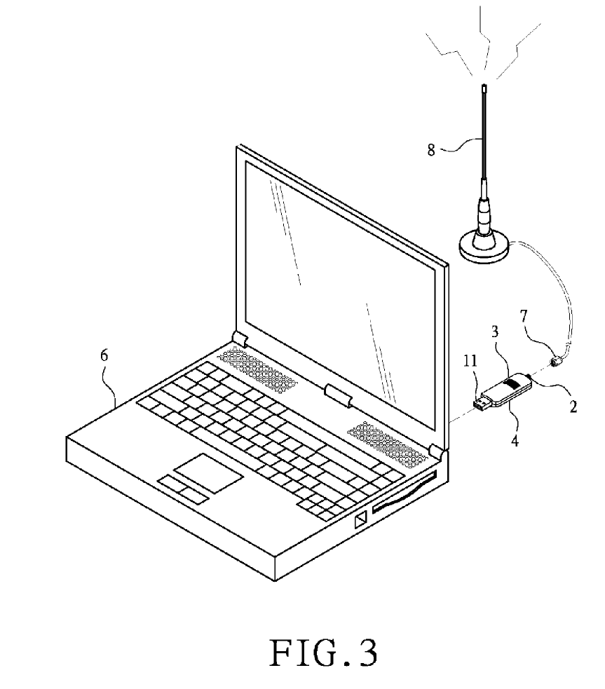

Referring to FIG. 3, in use the USB network adapter is connected to a laptop computer 6 through a USB port and the coaxial connector 2 is connectable a coaxial connector 7 extending from an antenna 8 to enhance the quality of the wireless communications. Thereafter, the user may operate the laptop computer 6 to connect to the Internet in a wireless manner. This installation is similar to plug and play and is thus very simple and easy.

While the invention herein disclosed has been described by means of specific embodiments, numerous modifications and variations could be made thereto by those skilled in the art without departing from the scope and spirit of the invention set forth in the claims.

What is claimed is:

1. A USB network adapter comprising a wireless network interface card contained in upper and lower shells and having a USB connector for connecting to a computer through a USB port; further comprising:
a coaxial connector extending from a signal receiver of the wireless network interface card and connectable to a coaxial connector of an antenna.

2. A USB network adapter according to claim 1, wherein each of the upper and lower shells having a half circular opening at one end, a half hexagonal flange located adjacent the half circular opening and a seat having a half circular recess for firmly holding the coaxial connector therebetween.

3. A USB network adapter according to claim 1, wherein the upper shell having a plurality of grilles for releasing heat generated from inside of the USB network adapter during operation.
